(19) United States
(12) Patent Application Publication
(10) Pub. No.: US 2026/0329451 A1
(43) Pub. Date: Oct. 22, 2026

(54) BULK OVERRIDE OF CONFIGURATION SETTINGS IN A MEMORY DEVICE BASED ON PROGRAM/ERASE CYCLE COUNT

(71) Applicant: Micron Technology, Inc., Boise, ID (US)

(72) Inventors: Chong Giap Chiew, San Jose, CA (US); Sean Brasfield, Boise, ID (US); Tawalin Opastrakoon, Boise, ID (US); Zhi Yin Chiew, Singapore (SG); Lee Boon Hao Mervin, Singapore (SG)

(21) Appl. No.: 19/182,455

(22) Filed: Apr. 17, 2025

(51) Int. Cl. G06F 3/06

(52) U.S. Cl. CPC G06F 3/0616; G06F 3/0629; G06F 3/0653; G06F 3/0673

(57) ABSTRACT

A memory sub-system includes a memory device and a memory sub-system controller configured to track a program-erase cycle (PEC) count of the memory device, determine that the PEC count of the memory device has reached a first threshold of a plurality of predetermined thresholds, and send a first command to the memory device, the first command comprising an indication of the first threshold and to cause control logic of the memory device to access a first configuration setting profile corresponding to the first threshold stored on the memory device and to configure a first subset of a plurality of configuration settings of the memory device according to the first configuration setting profile.

### TECHNICAL FIELD

Embodiments of the disclosure relate generally to memory sub-systems, and more specifically, relate to bulk override of configuration settings in a memory device of a memory sub-system based on program/erase cycle count.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with some embodiments of the present disclosure.

FIG. 1B is a block diagram of a memory device in communication with a memory sub-system controller of a memory sub-system, in accordance with some embodiments of the present disclosure.

FIG. 2 is a schematic of portions of an array of memory cells as could be used in a memory of the type described with reference to FIG. 1B in accordance with some embodiments of the present disclosure.

FIG. 3 is a flow diagram of an example method of memory sub-system operations for bulk override of configuration settings in a memory device of a memory sub-system based on program/erase cycle count in accordance with some embodiments of the present disclosure.

FIG. 4 is a flow diagram of an example method of memory device operations for bulk override of configuration settings in a memory device of a memory sub-system based on program/erase cycle count in accordance with some embodiments of the present disclosure.

FIG. 5 is a diagram illustrating configuration setting profile information corresponding to predetermined program-erase cycle (PEC) count thresholds and stored on a memory device in accordance with some embodiments of the present disclosure.

FIG. 6 is a block diagram of an example computer system in which embodiments of the present disclosure can operate.

### DETAILED DESCRIPTION

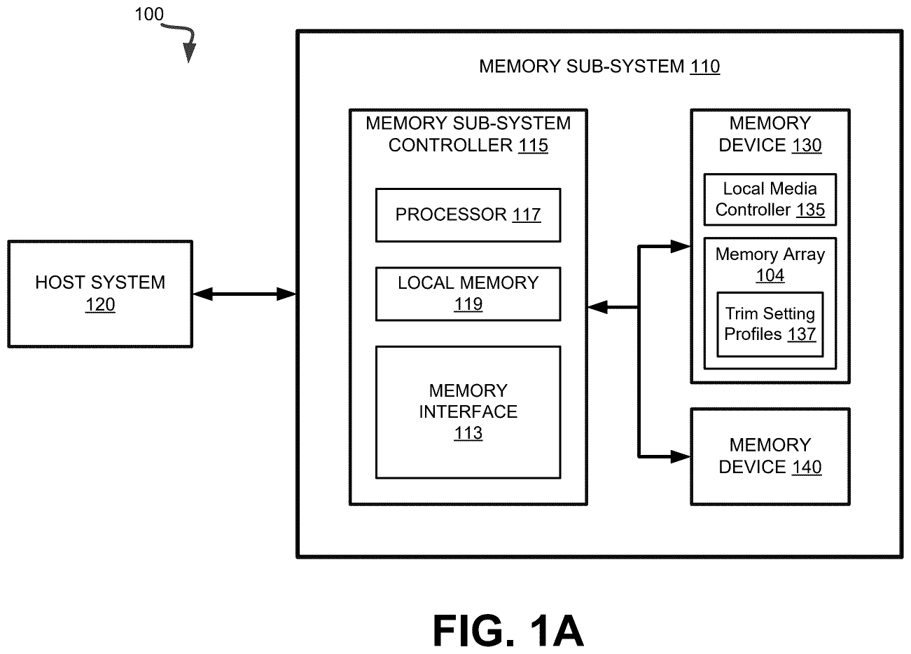

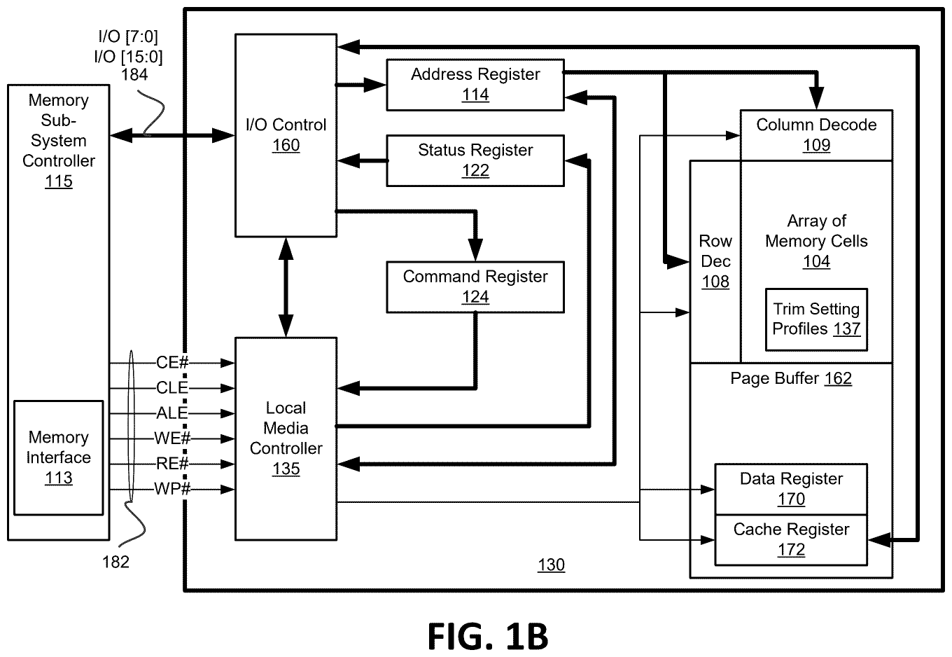

Aspects of the present disclosure are directed to bulk override of configuration settings in a memory device of a memory sub-system based on program/erase cycle count. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high-density configurations. A non-volatile memory device is a package of one or more dice, each including one or more planes. For some types of non-volatile memory devices (e.g., NAND memory), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bit lines) and rows (also hereinafter referred to as wordlines). A wordline can refer to one or more rows of memory cells of a memory device that are used with one or more bit lines to generate the address of each of the memory cells. The intersection of a bit line and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. Each data block can include a number of sub-blocks, where each sub-block is defined by an associated pillar (e.g., a vertical conductive trace) extending from a shared bitline. Memory pages (also referred to herein as “pages”) store one or more bits of binary data corresponding to data received from the host system. To achieve high density, a string of memory cells in a non-volatile memory device can be constructed to include a number of memory cells at least partially surrounding a pillar of channel material. The memory cells can be coupled to access lines, which are commonly referred to as “wordlines,” often fabricated in common with the memory cells, so as to form an array of strings in a block of memory. The compact nature of certain non-volatile memory devices, such as 3D flash NAND memory, means wordlines are common to many memory cells within a block of memory.

One example of a memory sub-system is a solid-state drive (SSD) that includes one or more non-volatile memory devices and a memory sub-system controller to manage the non-volatile memory devices. A given segment of one of those memory devices (e.g., a block) can be characterized based on the programming state of the memory cells associated with wordlines contained within the segment. When data is written to a memory cell of the segment for storage, the memory cell can deteriorate. Accordingly, each memory cell of the segment can handle a finite number of write operations performed before the memory cell is no longer able to reliably store data. The error rate associated with data stored at the data block can increase due to a number of factors, including read disturb, slow charge loss, the passage of time, change in temperature, etc.

Due to this degradation, the memory sub-system controller may adjust certain configuration settings (i.e., trim settings) during the life-time of the memory device. For example, as the program-erase cycle (PEC) count (i.e., the number of times that segments of the memory device have been programmed and subsequently erased) increases to certain levels, the memory sub-system controller may adjust such configuration settings as temperature compensation offsets for read and program verify voltage levels, read window sizes, corrective read voltage levels, etc. Depending on the memory device, there may be tens or even hundreds of different configuration settings that are adjusted. Each of these configuration settings may be adjusted multiple times (i.e., at multiple different PEC counts) over the lifetime of the memory device. Accordingly, updating these configuration settings can be a resource and time intensive task with significant system overhead.

Different memory sub-systems utilize different approaches to manage the update of the configuration settings. One approach is the use of a user selectable trim profile (USTP). USTP provides a relatively small set of configuration settings that can be updated, but is often too limited for the actual number of configuration settings that may need to be updated. In addition, USTP requires the memory device to be fully initialized before it can be used, which hurts system performance. Another approach is the use of the MLBi interface. Since MLBi only allows updating of a single configuration setting at a time, however, there is a significant impact to system performance when updating a large number of configuration settings. A further approach includes the use of a cache in the memory device which can be populated with the configuration settings by the memory sub-system controller or host system. This approach requires the entire set of configuration settings to be loaded into the cache at once, and so is ineffective if only a sub-set of the entire set of configuration settings is to be updated at a given time. Furthermore, the memory sub-system controller or host system has to have the configuration setting values in the first place in order to load them into the memory device cache.

Aspects of the present disclosure address the above and other deficiencies by implementing bulk override of configuration settings in a memory device of a memory sub-system based on program/erase cycle count. In one embodiment, respective configuration setting profiles corresponding to various different PEC count intervals can be predetermined and stored in a read-only section of the memory device during manufacturing. While the memory device is in use in a memory sub-system, the memory sub-system controller can track the PEC count of the memory device. When the PEC count reaches the specified intervals, the memory sub-system controller can send a command (e.g., including an opcode representing the PEC count interval) to the memory device to cause control logic on the memory device to retrieve a corresponding configuration setting profile from the read-only section of the memory device and update the configuration settings according to the profile.

Advantages of this approach include, but are not limited to, improved performance in the memory device. The techniques described herein allow any number of configuration settings in the memory device to be updated concurrently and with lower overhead than conventional techniques. Since the configuration setting profiles are pre-stored on the memory device, there is no need for the memory sub-system or host system to maintain the configuration settings.

Allowing the configuration settings to be updated at various different PEC count intervals can improve performance of the memory device, as well as increase reliability for data storage and increase the usable lifespan of the memory device.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

In one embodiment, the memory sub-system 110 includes a memory interface 113 that is responsible for handling interactions of memory sub-system controller 115 with the memory devices of memory sub-system 110, such as memory device 130. For example, the memory interface 113 can send memory access commands corresponding to requests received from host system 120 to memory device 130, such as program commands, read commands, or other commands. In addition, the memory interface 113 can receive data from memory device 130, such as data retrieved in response to a read command or a confirmation that a program command was successfully performed. In some embodiments, the memory sub-system controller 115 includes at least a portion of the memory interface 113. For example, the memory sub-system controller 115 can include a processor 117 (processing device) configured to execute instructions stored in local memory 119 for performing the operations described herein.

In one embodiment, memory interface 113 is configured to track a program-erase cycle (PEC) count of the memory device 130 and determine whether the PEC count of the memory device has reached any of a plurality of predetermined thresholds. Responsive to determining that the PEC count of the memory device has reached a given threshold, memory interface 113 can send a command to the memory device 130, the command comprising an indication of the threshold (e.g., an opcode) and to cause local media controller 135 of the memory device 130 to access a configuration setting profile corresponding to the first threshold, and which is stored on the memory device 130. For example, the memory device 130 can include a number of respective configuration setting (i.e., trim setting) profiles 137 corresponding to a plurality of predetermined PEC count thresholds for the memory device 130. Upon receiving the indication of the threshold, local media controller 135 can configure a first subset of a plurality of configuration settings of the memory device 130 according to the first configuration setting profile. Further details with regards to the operations of memory interface 113 and local media controller 135 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, memory sub-system controller 115 includes memory interface 113.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states. In one embodiment, array of memory cells 104 includes respective configuration setting (i.e., trim setting) profiles 137.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer 162 of the memory device 130. The page buffer 162 may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 182. For example, the control signals can include a chip enable signal CE#, a command latch enable signal CLE, an address latch enable signal ALE, a write enable signal WE#, a read enable signal RE#, and a write protect signal WP#. Additional or alternative control signals (not shown) may be further received over control link 182 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 184 and outputs data to the memory sub-system controller 115 over I/O bus 184.

For example, the commands may be received over input/output (I/O) pins [7:0] of I/O bus 184 at I/O control circuitry 160 and may then be written into command register 124. The addresses may be received over input/output (I/O) pins [7:0] of I/O bus 184 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

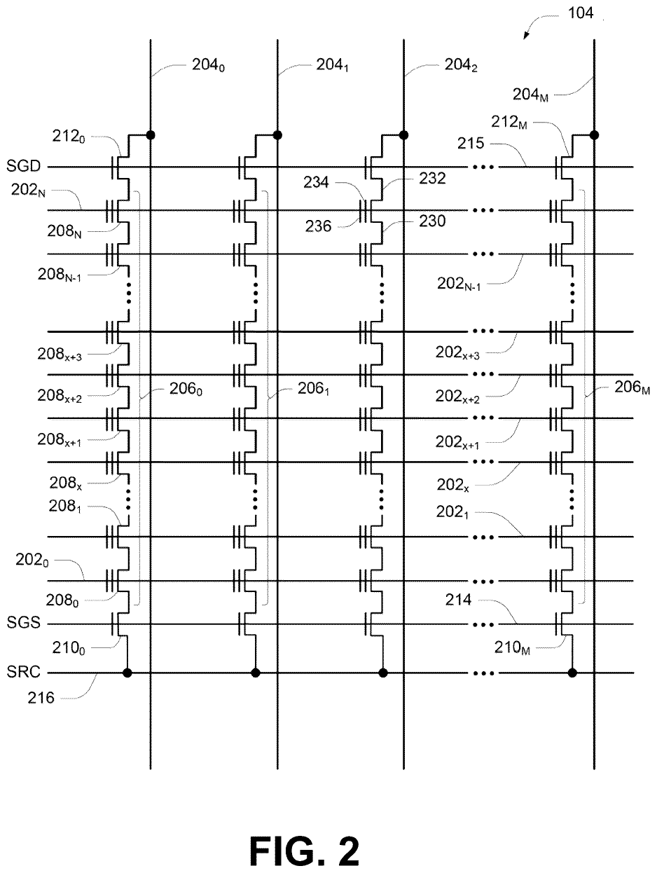

FIG. 2 is a schematic of portions of an array of memory cells 104, such as a NAND memory array, as could be used in a memory of the type described with reference to FIG. 1B according to an embodiment. Memory array 104 includes access lines, such as wordlines 202₀ to 202_{N}, and data lines, such as bit lines 204₀ to 204_{M}. The wordlines 202 can be connected to global access lines (e.g., global wordlines), not shown in FIG. 2, in a many-to-one relationship. For some embodiments, memory array 104 can be formed over a semiconductor that, for example, can be conductively doped to have a conductivity type, such as a p-type conductivity, e.g., to form a p-well, or an n-type conductivity, e.g., to form an n-well.

Memory array 104 can be arranged in rows (each corresponding to a wordline 202) and columns (each corresponding to a bit line 204). Each column can include a string of series-connected memory cells (e.g., non-volatile memory cells), such as one of NAND strings 206₀ to 206_{M}. Each NAND string 206 can be connected (e.g., selectively connected) to a common source (SRC) 216 and can include memory cells 208₀ to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀ to 210_{M} (e.g., that can be source select transistors, commonly referred to as select gate source), and a select gate 212 (e.g., a field-effect transistor), such as one of the select gates 212₀ to 212_{M} (e.g., that can be drain select transistors, commonly referred to as select gate drain). Select gates 210₀ to 210_{M} can be commonly connected to a select line 214, such as a source select line (SGS), and select gates 212₀ to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀ of the corresponding NAND string 206. For example, the drain of select gate 210₀ can be connected to memory cell 208₀ of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bit line 204 for the corresponding NAND string 206. For example, the drain of select gate 212₀ can be connected to the bit line 204₀ for the corresponding NAND string 206₀. The source of each select gate 212 can be connected to a memory cell 208_{N} of the corresponding NAND string 206. For example, the source of select gate 212₀ can be connected to memory cell 208_{N} of the corresponding NAND string 206₀. Therefore, each select gate 212 can be configured to selectively connect a corresponding NAND string 206 to the corresponding bit line 204. A control gate of each select gate 212 can be connected to select line 215.

The memory array 104 in FIG. 2 can be a quasi-two-dimensional memory array and can have a generally planar structure, e.g., where the common source 216, NAND strings 206 and bit lines 204 extend in substantially parallel planes. Alternatively, the memory array 104 in FIG. 2 can be a three-dimensional memory array, e.g., where NAND strings 206 can extend substantially perpendicular to a plane containing the common source 216 and to a plane containing the bit lines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bit line 204. A row of the memory cells 208 can be memory cells 208 commonly connected to a given wordline 202. A row of memory cells 208 can, but need not, include all the memory cells 208 commonly connected to a given wordline 202.

Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bit lines 204 (e.g., bit lines 204₀, 204₂, 204₄, etc.) can be one physical page of the memory cells 208 (e.g., even memory cells) while memory cells 208 commonly connected to wordline 202_{N} and selectively connected to odd bit lines 204 (e.g., bit lines 204₁, 204₃, 204₅, etc.) can be another physical page of the memory cells 208 (e.g., odd memory cells).

Although bit lines 204₃-204₅ are not explicitly depicted in FIG. 2, it is apparent from the figure that the bit lines 204 of the array of memory cells 104 can be numbered consecutively from bit line 204₀ to bit line 20₄M. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2 is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

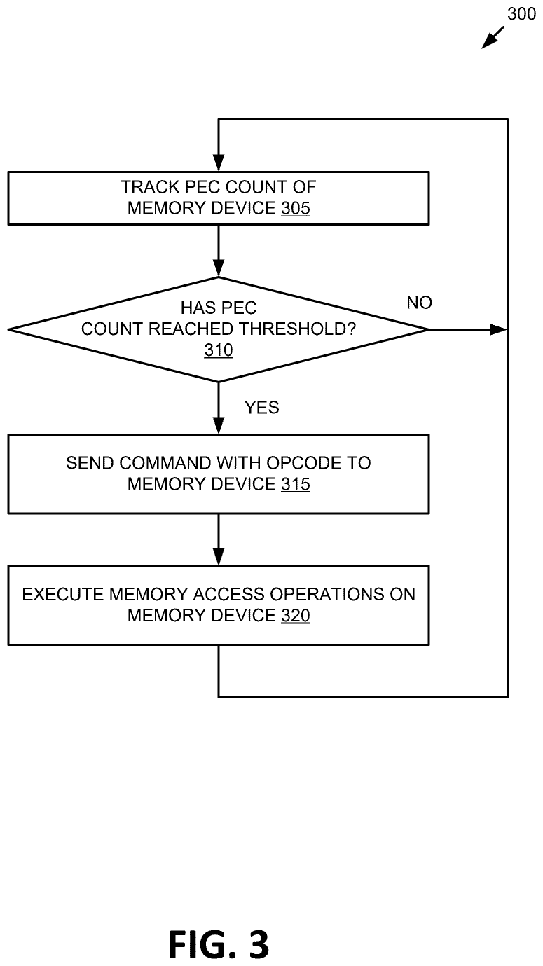

FIG. 3 is a flow diagram of an example method of memory sub-system operations for bulk override of configuration settings in a memory device of a memory sub-system based on program/erase cycle count in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by memory sub-system controller 115 of FIG. 1A and FIG. 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing logic (e.g., memory interface 113 of memory sub-system controller 115) tracks a program-erase cycle (PEC) count of a memory device, such as memory device 130. In one embodiment, the PEC count represents a number of times that certain segments of the memory device 130 have been programmed and subsequently erased so that new data can be reprogrammed in the future. In one embodiment, the processing logic maintains counters for different segments (e.g., blocks, superblocks) of the memory device 130 and which can be incremented each time a PEC occurs with the corresponding segment. The processing logic can use a representative value to represent the PEC of the entire memory device 130. For example, tracking the PEC count of the memory device 130 can include determining an average PEC count among a plurality of segments of the memory device 130. In other embodiments, some other representative value can be used.

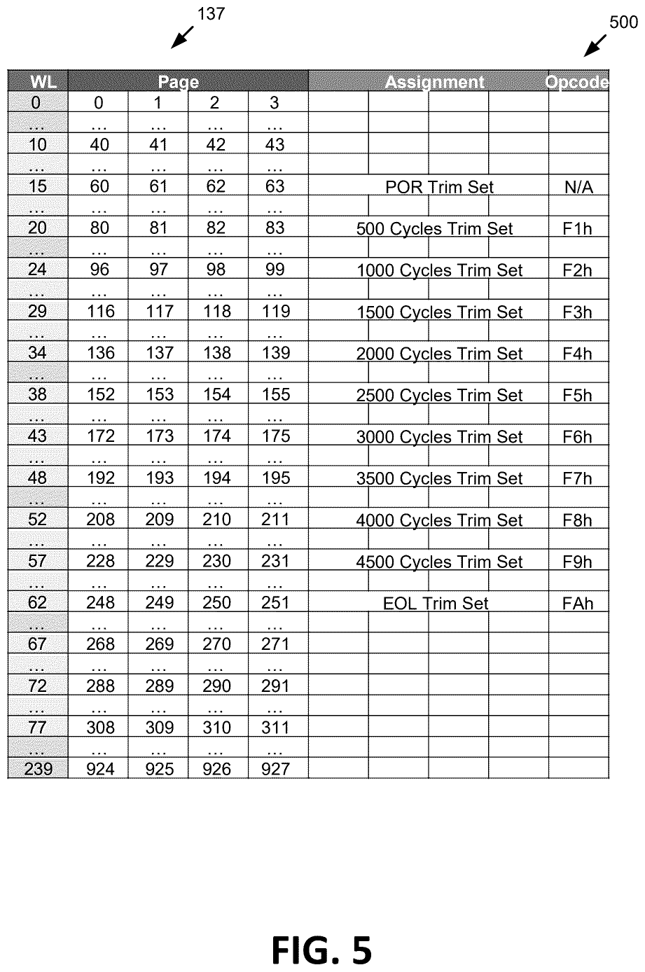

At operation 310, the processing logic determines whether the PEC count of the memory device has reached a threshold of a plurality of predetermined thresholds. In one embodiment, the plurality of predetermined thresholds are defined to represent respective points in the lifespan of the memory device 130 when updates to the configuration settings (i.e., trim settings) can be made to improve operation of the memory device 130. For example, these thresholds can be defined using respective numbers of program-erase cycles. In some embodiments, the predetermined thresholds are defined at regular intervals (e.g., every 500 or 1000 program-erase cycles). In other embodiments, the intervals between thresholds vary. In the example illustrated in FIG. 5, a number of different configuration setting profiles 137 are defined at regular intervals (i.e., 500 cycles, 1000 cycles, 1500 cycles . . . 4000, 4500 cycles). The processing logic can thus periodically compare the current PEC count determined at operation 305 to the predetermined thresholds. If the current PEC count is equal to or greater than one of the predetermined thresholds, the processing logic can determine that the threshold has been met (i.e., that the PEC count satisfies a threshold criterion).

Responsive to determining that the PEC count of the memory device has reached a threshold, at operation 315, the processing logic sends a command to the memory device 130, the command comprising an indication of the threshold. For example, the command may include an operation code (i.e., an opcode) that uniquely corresponds to the identified threshold.

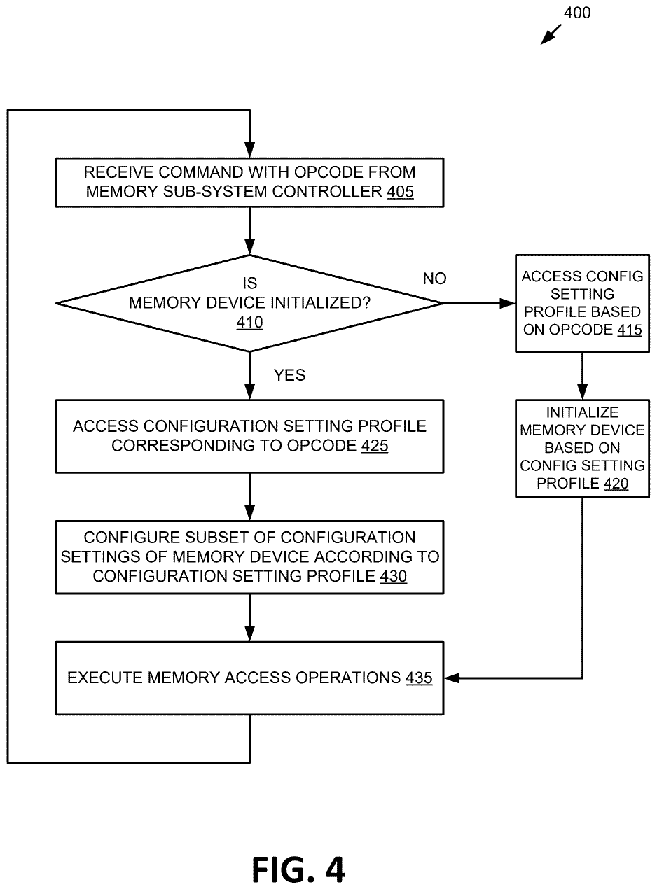

Accordingly, there may be a different opcode representing each of the predetermined thresholds. As illustrated in the example of FIG. 5, the threshold of 500 cycles has an opcode of “F1h,” the threshold of 1000 cycles has an opcode of “F2h,” the threshold of 1500 cycles has an opcode of “F3h,” etc. In one embodiment, as described in more detail below, with respect to FIG. 4, the command causes control logic of the memory device 130 (e.g., memory sub-system controller 135) to access a configuration setting profile corresponding to the threshold identified by the opcode and stored on the memory device 130. The control logic of the memory device 130 can further configure a subset of a plurality of configuration settings of the memory device 130 according to the configuration setting profile. As illustrated in chart 500 of FIG. 5, a plurality of respective configuration setting profiles 137 corresponding to the plurality of predetermined thresholds are stored on the memory device 130. Each configuration setting profile is stored on pages of a respective wordline (WL) and comprises values for respective subsets of the plurality of configuration settings of the memory device 130. These values are calibrated to account for degradation experienced at corresponding PEC counts defined by the plurality of predetermined thresholds. Examples of the configuration settings can include temperature compensation offsets for read and program verify voltage levels, read window sizes, corrective read voltage levels, etc. Depending on the memory device 130, there may be tens or even hundreds of different configuration settings that are adjusted in each subset.

At operation 320, the processing logic executes one or more memory access operations on the memory device 130 having the subset of the plurality of configuration settings configured according to the configuration setting profile. For example, as memory access requests are received (e.g., from the host system 120), memory sub-system controller 115 can issue corresponding commands to the memory device 130 to perform the memory access operations (e.g., read operations, program operations, erase operations). These operations can thus be performed using the updated configuration settings in order to optimize performance, data retention, wear, error rates, etc. in the memory device 130.

Processing can return to operation 305, and upon determining, at operation 310, that the PEC count of the memory device 130 has reached another threshold of the plurality of predetermined thresholds (e.g., a second threshold), at operation 315, the processing logic sends a second command to the memory device, the second command comprising an indication of the second threshold and to cause the control logic of the memory device 130 to access a second configuration setting profile corresponding to the second threshold stored on the memory device 130 and to configure a second subset of the plurality of configuration settings of the memory device 130 according to the second configuration setting profile. In one embodiment, the second threshold is larger than the first threshold, and the second subset of the plurality of configuration settings is different than the first subset of the plurality of configuration settings. For example, if the PEC count previously met the 500 cycle threshold, and the memory device 130 had previously been configured according to the configuration setting profile represented by opcode “F1h” and store at wordline 20 (i.e., pages 80-83), when the processing logic determines that the PEC count has now reached the 1000 cycle threshold, the processing logic can send a command with opcode “F2h” causing the control logic of the memory device to access the configuration setting profile stored at wordline 24 (i.e., pages 96-99) and configure the configuration settings accordingly. This process may repeat as the PEC count of the memory device continues to increase.

FIG. 4 is a flow diagram of an example method of memory device operations for bulk override of configuration settings in a memory device of a memory sub-system based on program/erase cycle count in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by local media controller 135 of FIG. 1A and FIG. 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing logic (e.g., local media controller 135) receives a command from a memory sub-system controller 115, the command comprising an indication (e.g., an opcode) of a program-erase cycle (PEC) count threshold of the memory device 130. As described above, the command may include an operation code (i.e., an opcode) that uniquely corresponds to the associated threshold. The PEC count threshold may be one of a plurality of predetermined PEC count thresholds, and there may be a different opcode representing each of the predetermined thresholds, as illustrated in the example of FIG. 5. Each opcode corresponds to a respective configuration setting profile 137 stored on the memory device 130, and each configuration setting profile 137 includes values for a respective subset of a plurality of configuration settings of the memory device 130.

At operation 410, the processing logic determines whether the memory device 130 has been initialized. Initialization of the memory device 130 is performed periodically (e.g., after a power-cycle) in order to restart and ensure reliable operation. Initialization may begin with identifying and marking bad blocks to prevent data corruption, followed by configuring an Error Correction Code (ECC) engine to mitigate bit errors. Wear leveling algorithms are initialized to distribute write/erase cycles evenly, and the control logic is configured with appropriate configuration settings. If a power-cycle event has recently occurred, it is possible that the memory device 130 may not yet have been initialized, and thus may be in an uninitialized state. Otherwise, if the memory device 130 has already been in operation, the memory device 130 may have previously been initialized.

If the memory device 130 has not been initialized, at operation 415, the processing logic accesses a configuration setting profile corresponding to the PEC count threshold stored in the memory array. As illustrated in chart 500 of FIG. 5, a plurality of respective configuration setting profiles 137 corresponding to the plurality of predetermined thresholds are stored on the memory device 130. Each configuration setting profile is stored on pages of a respective wordline (WL) and comprises values for respective subsets of the plurality of configuration settings of the memory device 130. These values are calibrated to account for degradation experienced at corresponding PEC counts defined by the plurality of predetermined thresholds. Examples of the configuration settings can include temperature compensation offsets for read and program verify voltage levels, read window sizes, corrective read voltage levels, etc. Using the opcode in the received command, the processing logic can identify the corresponding configuration setting profile from the memory device 130.

At operation 420, the processing logic initializes the memory device according to the configuration setting profile. Since the memory device 130 has not yet been initialized, the processing logic can initialize the memory device 130 using the values of the configuration settings in the identified configuration setting profile. Accordingly, rather than initializing the memory device 130 with default initial configurations settings and then having to update those settings to the appropriate values based on the PEC count, the processing logic can initialize the memory device 130 directly with the appropriate values.

If the memory device 130 has already been initialized, at operation 425, the processing logic accesses a configuration setting profile corresponding to the PEC count threshold stored in the memory array. As illustrated in chart 500 of FIG. 5, a plurality of respective configuration setting profiles 137 corresponding to the plurality of predetermined thresholds are stored on the memory device 130. Each configuration setting profile is stored on pages of a respective wordline (WL) and comprises values for respective subsets of the plurality of configuration settings of the memory device 130. These values are calibrated to account for degradation experienced at corresponding PEC counts defined by the plurality of predetermined thresholds. Examples of the configuration settings can include temperature compensation offsets for read and program verify voltage levels, read window sizes, corrective read voltage levels, etc. Using the opcode in the received command, the processing logic can identify the corresponding configuration setting profile from the memory device 130.

At operation 430, the processing logic configures a subset of a plurality of configuration settings of the memory device according to the configuration setting profile. The processing logic can write the corresponding values from the configuration setting profile to the registers which control the corresponding configuration settings for the memory device 130. This may include overwriting previous values in those registers.

At operation 435, the processing logic executes one or more memory access operations on the memory array having the subset of the plurality of configuration settings configured according to the configuration setting profile. For example, as memory access commands are received (e.g., from the memory sub-system controller 115), the local media controller 135 can perform those operations (e.g., read operations, program operations, erase operations) on the memory array 104 These operations can thus be performed using the updated configuration settings in order to optimize performance, data retention, wear, error rates, etc. in the memory device 130.

Processing can return to operation 405, and upon receiving another command from the memory sub-system controller, and including an indication of another PEC count threshold of the memory device, at operation 425, the processing logic can access another configuration setting profile corresponding to the second threshold stored in the memory array, and at operation 430, configure another subset of a plurality of configuration settings of the memory device according to another configuration setting profile. In some embodiments, the second PEC count threshold is larger than the first PEC count threshold, and the second subset of the plurality of configuration settings is different than the first subset of the plurality of configuration settings.

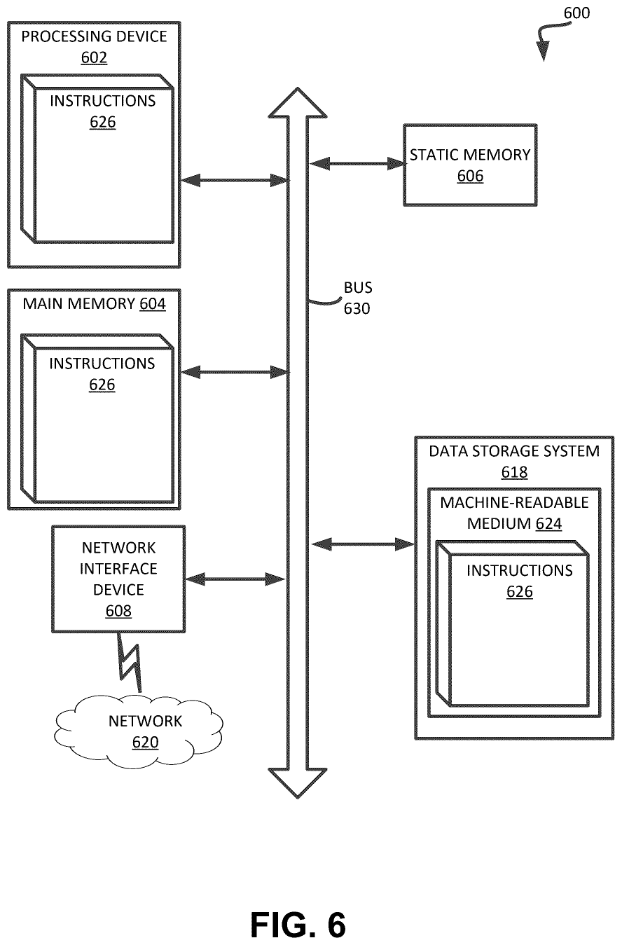

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to memory sub-system controller 115 or local media controller 135 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1A.

In one embodiment, the instructions 626 include instructions to implement functionality corresponding to the memory sub-system controller 115 or local media controller 135 of FIG. 1A. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
tracking a program-erase cycle (PEC) count of the memory device;
determining that the PEC count of the memory device has reached a first threshold of a plurality of predetermined thresholds; and
sending a first command to the memory device, the first command comprising an indication of the first threshold and to cause control logic of the memory device to access a first configuration setting profile corresponding to the first threshold stored on the memory device and to configure a first subset of a plurality of memory access operation configuration settings of the memory device according to the first configuration setting profile, the first subset including multiple different configuration settings.

2. The system of claim 1, wherein a plurality of respective configuration setting profiles corresponding to the plurality of predetermined thresholds are stored on the memory device.

3. The system of claim 2, wherein the plurality of respective configuration setting profiles each comprise values for respective subsets of the plurality of configuration settings of the memory device, and wherein the values are calibrated to account for degradation experienced at corresponding PEC counts defined by the plurality of predetermined thresholds.

4. The system of claim 1, wherein tracking the PEC count of the memory device comprises determining an average PEC count among a plurality of segments of the memory device.

5. The system of claim 1, wherein the processing device is to perform operations further comprising:
executing one or more memory access operations on the memory device having the first subset of the plurality of configuration settings configured according to the first configuration setting profile.

6. The system of claim 1, wherein the processing device is to perform operations further comprising:
determining that the PEC count of the memory device has reached a second threshold of the plurality of predetermined thresholds; and
sending a second command to the memory device, the second command comprising an indication of the second threshold and to cause the control logic of the memory device to access a second configuration setting profile corresponding to the second threshold stored on the memory device and to configure a second subset of the plurality of configuration settings of the memory device according to the second configuration setting profile.

7. The system of claim 6, wherein the second threshold is larger than the first threshold, and wherein the second subset of the plurality of configuration settings is different than the first subset of the plurality of configuration settings.

8. A method comprising:
tracking a program-erase cycle (PEC) count of a memory device;
determining that the PEC count of the memory device has reached a first threshold of a plurality of predetermined thresholds; and
sending, by a memory sub-system controller, a first command to the memory device, the first command comprising an indication of the first threshold and to cause control logic of the memory device to access a first configuration setting profile corresponding to the first threshold stored on the memory device and to configure a first subset of a plurality of memory access operation configuration settings of the memory device according to the first configuration setting profile, the first subset including multiple different configuration settings.

9. The method of claim 8, wherein a plurality of respective configuration setting profiles corresponding to the plurality of predetermined thresholds are stored on the memory device.

10. The method of claim 9, wherein the plurality of respective configuration setting profiles each comprise values for respective subsets of the plurality of configuration settings of the memory device, and wherein the values are calibrated to account for degradation experienced at corresponding PEC counts defined by the plurality of predetermined thresholds.

11. The method of claim 8, wherein tracking the PEC count of the memory device comprises determining an average PEC count among a plurality of segments of the memory device.

12. The method of claim 8, further comprising:
executing one or more memory access operations on the memory device having the first subset of the plurality of configuration settings configured according to the first configuration setting profile.

13. The method of claim 8, further comprising:
determining that the PEC count of the memory device has reached a second threshold of the plurality of predetermined thresholds; and
sending a second command to the memory device, the second command comprising an indication of the second threshold and to cause the control logic of the memory device to access a second configuration setting profile corresponding to the second threshold stored on the memory device and to configure a second subset of the plurality of configuration settings of the memory device according to the second configuration setting profile.

14. The method of claim 13, wherein the second threshold is larger than the first threshold, and wherein the second subset of the plurality of configuration settings is different than the first subset of the plurality of configuration settings.

15. A memory device comprising:
a memory array; and
control logic, operatively coupled with the memory array, to perform operations comprising:
receiving a first command from a memory sub-system controller, the first command comprising an indication of a first program-erase cycle (PEC) count threshold of the memory device;
accessing a first configuration setting profile corresponding to the first PEC count threshold stored in the memory array; and
configuring a first subset of a plurality of memory access operation configuration settings of the memory device according to the first configuration setting profile, the first subset including multiple different configuration settings.

16. The memory device of claim 15, wherein the first PEC count threshold is one of a plurality of predetermined PEC count thresholds, and wherein a plurality of respective configuration setting profiles corresponding to the plurality of predetermined PEC count thresholds are stored in the memory array.

17. The memory device of claim 16, wherein the plurality of respective configuration setting profiles each comprise values for respective subsets of the plurality of configuration settings of the memory device, and wherein the values are calibrated to account for degradation experienced at corresponding PEC counts defined by the plurality of predetermined thresholds.

18. The memory device of claim 15, wherein the control logic is to perform operations further comprising:
executing one or more memory access operations on the memory array having the first subset of the plurality of configuration settings configured according to the first configuration setting profile.

19. The memory device of claim 15, wherein the control logic is to perform operations further comprising:
receiving a second command from the memory sub-system controller, the second command comprising an indication of second PEC count threshold of the memory device;
accessing a second configuration setting profile corresponding to the second threshold stored in the memory array; and
configuring a second subset of a plurality of configuration settings of the memory device according to the second configuration setting profile.

20. The memory device of claim 19, wherein the second PEC count threshold is larger than the first PEC count threshold, and wherein the second subset of the plurality of configuration settings is different than the first subset of the plurality of configuration settings.
